(19) United States
(12) Patent Application Publication
(10) Pub. No.: US 2008/0116351 A1
(43) Pub. Date: May 22, 2008

(54) GANTRY SYSTEM FOR IMAGING DEVICE

(75) Inventors: Vikram Keertikumar Dave, Bangalore (IN); Baskar Somasundaram, Bangalore (IN)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/562,606

(22) Filed: Nov. 22, 2006

(51) Int. Cl. F16M 13/00

(52) U.S. Cl. 248/646; 250/522.1

(57) ABSTRACT

An embodiment provides a ceiling mounted gantry system comprising a carriage, at least two elongated support rails placed beneath the ceiling and extending between the opposing sides of the carriage, a support structure coupled to the carriage, a primary drive assembly and a secondary drive assembly mounted on the carriage. The ceiling mounted gantry system may further comprise a first belt coupled to the primary drive assembly and a second belt coupled to the secondary drive assembly.

### FIELD OF INVENTION

This invention relates generally to an imaging device and more particularly to a gantry system in an imaging device.

### BACKGROUND OF THE INVENTION

The use of imaging devices in medical field is well known. The imaging device configured for imaging an object provides a radiologist with detailed internal views of the anatomy of the object. Further, the use of the imaging device such as an MRI system to guide the focal point of an ultrasonic therapy device to selectively destroy tumors or other tissue anomalies is known. The need to accurately position an ultrasonic transducer for use in selective tissue necrosis presents special problems when used in combination with the imaging device.

Typically, the imaging device comprises a radiation source and a radiation detector. The imaging device can further comprise a gantry system to support the radiation source and the radiation detector. The gantry system can be movably fixed to a stationary structure such as a ceiling. Typically, the gantry system fixed to the ceiling is referred to as a ceiling mounted gantry system.

The ceiling mounted gantry system generally comprises a carriage, at least two elongated support rails placed beneath the ceiling and extending between the opposing sides of the carriage, a support structure coupled to the carriage and a primary drive assembly mounted on the carriage. The ceiling mounted gantry system can further comprise a belt coupled to the primary drive assembly. The belt can be extended parallel to the support rails and can be tensioned between the two ends to maintain the belt at a stationary position. Further, the primary drive assembly can comprise a drive motor, a transmission apparatus coupled to the drive motor and one or more primary timer pulleys coupled to the drive motor through the transmission apparatus. The drive motor is configured to drive the primary timer pulley through the transmission apparatus coupled thereto. The primary timer pulley is configured to move along the belt maintained at the stationary position. The primary drive assembly can further comprise a feedback device such as a motor encoder to provide information about the position of the carriage.

The primary limitation in using the known ceiling mounted gantry system is a single point failure of the belt resulting from an overload. Another limitation in using the known ceiling mounted gantry system is the inability to track the exact position of the carriage with respect to the support rails. The inability to track the exact position of the carriage results from the motion loss induced by a slippage due to a backlash in the transmission apparatus. Yet another limitation in using the known ceiling mounted gantry system is, during power on conditions the motion of the carriage cannot be controlled with a short notice. For example, the carriage cannot be immediately brought to halt in an occurrence of a collision. The inability to control the motion of the carriage during emergency situations can result in damaging the surrounding environment including the object being imaged, and can result in injury to an operator of the imaging device.

Hence there exists a need to provide a gantry system comprising a simpler, robust and reliable mechanism for displacing the carriage.

### BRIEF DESCRIPTION OF THE INVENTION

The above-mentioned shortcomings, disadvantages and problems are addressed herein which will be understood by reading and understanding the following specification.

An embodiment provides a ceiling mounted gantry system comprising a carriage, at least two elongated support rails placed beneath the ceiling and extending between opposing sides of the carriage, a support structure coupled to the carriage, a primary drive assembly mounted on the carriage and a secondary drive assembly mounted on the carriage. The ceiling mounted gantry system may further comprise a first belt coupled to the primary drive assembly and a second belt coupled to the secondary drive assembly.

In another embodiment, a ceiling mounted gantry system for an imaging device is provided. The ceiling mounted gantry system comprises a carriage, a support structure coupled to the carriage, at least two elongated support rails placed beneath the ceiling and extending between opposing sides of the carriage, primary drive means for driving the carriage, and secondary drive means for driving the carriage.

In yet another embodiment, an imaging device comprising a ceiling mounted gantry system is provided. The ceiling mounted gantry system comprises a carriage, at least two elongated support rails placed beneath the ceiling and extending between opposing sides of the carriage, a support structure coupled to the carriage, a primary drive assembly coupled to the carriage and a secondary drive assembly coupled to the carriage. The imaging device further comprises a radiation source and a radiation detector coupled to the support structure of the ceiling mounted gantry system.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a schematic diagram of an imaging device in an embodiment of the invention;

FIG. 2 shows a schematic diagram of a ceiling mounted gantry system in an embodiment of the invention;

FIG. 3 shows a schematic diagram of a part of the ceiling mounted gantry system shown at FIG. 2;

FIG. 4 shows a schematic diagram of a primary drive assembly of the ceiling mounted gantry system in an embodiment of the invention; and

FIG. 5 shows a schematic diagram of a secondary drive assembly of the ceiling mounted gantry system in an embodiment of the invention.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

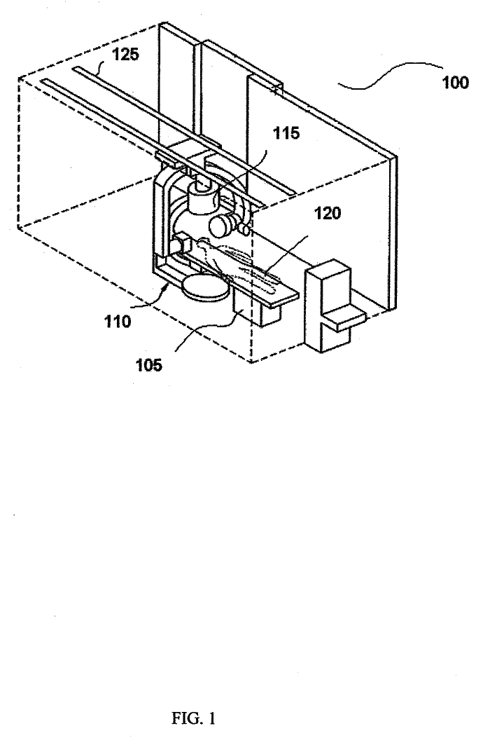

FIG. 1 shows a schematic diagram of an example of an imaging device 100. The imaging device 100 can be one of a computed tomography device, a positron emission tomography device, a magnetic resonance imaging device, an ultrasound-imaging device and an X ray device. One skilled in the art shall however appreciate that, the examples of the imaging device 100 are not limited to the examples mentioned above and the invention shall have full scope of the claims.

The imaging device 100 configured for imaging an object 120 comprises a patient positioning system 105, a radiation source 110 and a radiation detector 115. The patient positioning system 105 engages and supports the object 120 to be scanned. The radiation source 110 and the radiation detector 115 are configured for performing imaging on the object 120 positioned on the patient positioning system 105. The radiation source 110 is configured for generating electromagnetic radiation for projection towards the object 120 to be scanned. The electromagnetic radiation includes X rays, gamma rays and other HF electromagnetic energy. The X rays incident on the object 120 being scanned are attenuated by the object 120. The radiation detector 115 comprises multiple detector elements for converting the attenuated X rays into electrical signals. The electrical signals from the detector elements are further sampled and converted into digital signals for computer processing. The imaging device 100 further comprises a ceiling mounted gantry system 125 configured for supporting the radiation source 110 and the radiation detector 115.

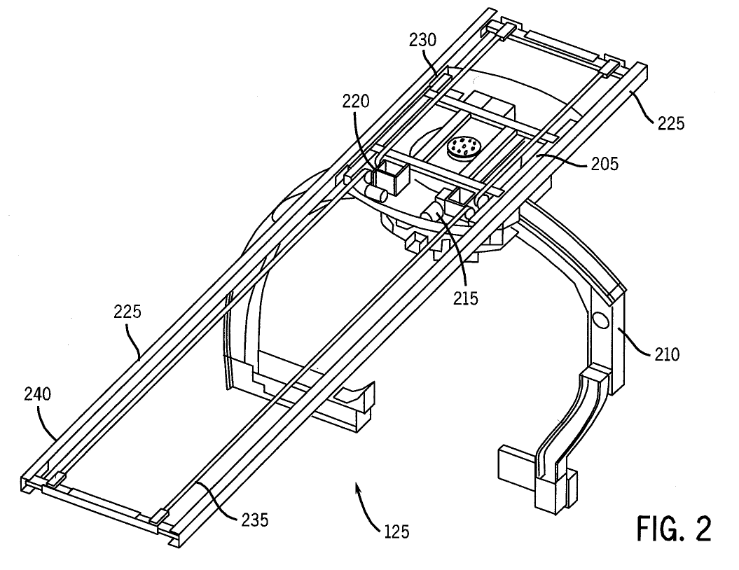

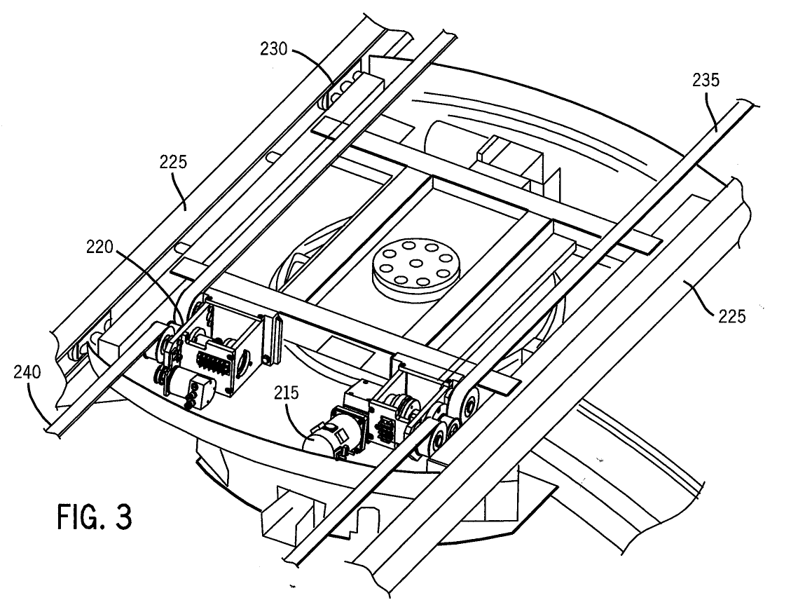

Referring to FIG. 2, the ceiling mounted gantry system 125 is shown in greater detail. The ceiling mounted gantry system 125 comprises a carriage 205, a support structure 210 coupled to the carriage 205, a dual drive assembly comprising a primary drive assembly 215 and a secondary drive assembly 220 mounted on the carriage 205. The support structure 210 can be circular in shape exhibiting multiple shapes ranging from an arc to a circle. The radiation source 110 and the radiation detector 115 can be positioned at approximately 180 degrees apart around the circumference of the support structure 210. The ceiling mounted gantry system 125 further includes support rails 225 for engaging the longitudinal slide of the carriage 205. The support rails 225 are two elongated support rails 225 placed beneath the ceiling and extending between the opposing sides of the carriage 205. The support rails 225 may further comprise multiple rollers 230 to facilitate the sliding motion of the carriage 205. This is shown at FIG. 3 in an enlarged view of a part of the ceiling mounted gantry system 125 shown at FIG. 2.

The elements, which are the same as or correspond to elements of FIG. 2, are denoted by the same reference numerals, so that in this sense the description need not be repeated and only the differences will be dealt with.

The primary drive assembly 215 and the secondary drive assembly 220 can each be driven through a belt drive for example of omega type. Accordingly, the ceiling mounted gantry system 125 may further comprise a first belt 235 coupled to the primary drive assembly 215 and a second belt 240 coupled to the secondary drive assembly 220. The first belt 235 and the second belt 240 are positive drive elements and when tensioned to a predetermined value avoid any chances of motion slippage and thus provide a smooth motion.

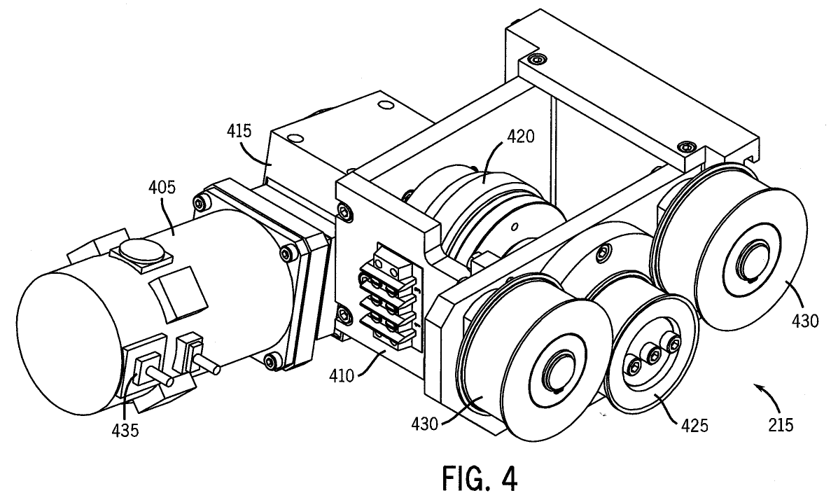

Each of the primary drive assembly 215 and the secondary drive assembly 220 are responsible for a distinct direction of motion of the carriage 205. The primary drive assembly 215 drives the carriage 205 in a direction parallel to the direction of movement of the object 120. FIG. 4 shows a typical detail of the primary drive assembly 215. The primary drive assembly 215 comprises a drive motor 405, a transmission apparatus 410 comprising a gearbox 415 and a clutch 420 coupled to the drive motor 405 and at least one primary timer pulley 425 coupled to the drive motor 405 through the transmission apparatus 410.

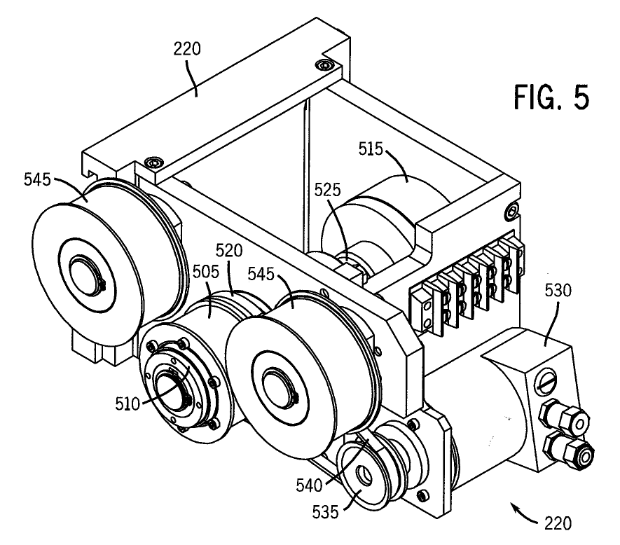

The drive motor 405 can be a stepper or a servomotor operating on a D.C (direct current) power supply. The rotary motion of the drive motor 405 is translated into either a lateral/longitudinal movement of the carriage 205 by the transmission apparatus 410. The gearbox 415 connected to the drive motor 405 drives the clutch 420 through a drive key. The rotation of the clutch 420 drives the primary timer pulley 425 over the first belt 235. The first belt 235 extends parallel along the length of the support rails 225 and is fixed to the shafts extending perpendicular to the support rails 225. A tensioning mechanism ensures that the first belt 235 remains at a stationary position and transfers the rotary motion of the primary drive assembly 215 with minimal backlash. The detailed operation of the primary drive assembly 215 is further explained in conjunction with FIG. 5.

The rotary motion of the primary drive assembly 215 initiates the rotation of the secondary drive assembly 220. FIG. 5 represents a schematic diagram of the secondary drive assembly 220. The secondary drive assembly 220 mounted on the carriage 205 comprises at least one secondary timer pulley 505, a torque limiter 510 coupled to the secondary timer pulley 505 and a brake device 515 coupled to the torque limiter 510. The torque limiter 510 along with the secondary timer pulley 505 moves over the second belt 240 due to the rotation of the primary drive assembly 215.

The secondary drive assembly 220 further comprises at least one pair of friction pads (not shown). The friction pads (not shown) include tension springs (not shown) that fasten the friction pads (not shown) to the torque limiter 510. The tension springs (not shown) can be set to a predetermined value termed as a torque limiter set value. The tension springs (not shown) produce a high amount of friction between the friction pads (not shown) and the torque limiter 510 and result in the torque limiter 510 acting as a brake for the secondary timer pulley 505. The brake device 515 can be energized by cutting off the power supply and the torque limiter 510 can be activated by energizing the brake device 515. The torque limiter 510 when activated ceases the motion of the carriage 205.

The torque limiter 510 further comprises a torque limiter shaft 525. The first end of the torque limiter shaft 525 holds the secondary timer pulley 505 through the friction pads (not shown), the friction pads (not shown) being controlled by the tension springs (not shown). The second end of the torque limiter shaft 525 can be coupled to the brake device 515 such as an electromagnetic brake.

The brake device 515 is configured to hold the torque limiter shaft 525 rigidly enough to enable the torque limiter 510 comprising the torque limiter shaft 525 to stop the motion of the secondary timer pulley 505 during a power off condition. During a power on condition, the brake device 515 can be disengaged through a DC power supply in the range of few volts. For example 24 Volts supply. During emergency or mal-functioning, the brake device 515 can be employed to hold the torque limiter shaft 525 with a force at least equal to the torque limiter set value. The torque limiter shaft 525 when held by the brake device 515 results in ceasing the motion of the carriage 205.

Considering two scenarios, when the power to the ceiling mounted gantry system 125 is on and when the power is off, in the first scenario when the power is on, the drive motor 405, the gearbox 415 coupled to the drive motor 405 and the primary timer pulley 425 drive the carriage 205. The connecting member between the gearbox 415 and the primary timer pulley 425 is the clutch 420. The clutch 420 can be of friction type and can be operated using PWM (Pulse Width Modulation) technique.

The PWM technique can be used to control the power supplied to the clutch 420. The power supplied to the clutch 420 in turn controls the speed of the carriage 205. The PWM driving signals comprise control pulses of fixed height, fixed frequency and variable pulse width. In the PWM technique, controlling the pulse width of the driving signals controls the power to the clutch 420. As the pulse width varies so does the power delivered to the clutch 420. As the power delivered to the clutch 420 varies, so does the speed of the carriage 205.

Thus when the ceiling mounted gantry system 125 is to be accelerated to a maximum speed the clutch 420 is powered to a maximum capacity for a predetermined time period and upon reaching the maximum speed of the ceiling mounted gantry system 125 the power to the clutch 420 can be switched to a desired transmitting torque. The desired transmitting torque can be of value proportional to the torque limiter set value. The desired transmitting torque is generally less than the maximum capacity of the clutch 420. Therefore, in case the ceiling mounted gantry system 125 meets with a collision or obstacle the clutch 420 automatically slips. The clutch 420 when slipped avoids causing any harm to the neighboring environment or the equipment.

In the second scenario i.e. when the power to the ceiling mounted gantry system 125 is off or during the failure of the first belt 235, the second belt 240 is useful. The brake device 515 activated during the power off conditions helps to stop the motion of the carriage 205 through the torque limiter 510. Alternatively and advantageously, the ceiling mounted gantry system 125 can be moved manually in power off conditions using a force equivalent to the torque limiter set value.

Thus during the failure of the first belt 235, the secondary drive assembly 220 helps in preventing the motion of the carriage 205 through the brake device 515 and the torque limiter 510. Alternatively, during the failure of the second belt 240 the motion of the ceiling mounted gantry system 125 can be brought to halt with the help of the clutch 420 operating in the primary drive assembly 215. Thus the ceiling mounted gantry system 125 empowered with dual belts eliminates a single point failure of the first belt 235.

Still referring to FIG. 5, in one embodiment, the secondary drive assembly 220 can comprise an encoder driver pulley 520 and an encoder driven pulley 535. The encoder driver pulley 520 can be positioned adjacent to the secondary timer pulley 505 and can be coupled to the secondary timer pulley 505 for example using screws or any such mechanism. Further, skilled artisans shall however appreciate that the primary drive assembly 215 and the secondary drive assembly 220 can comprise multiple idler pulleys 430 and 545 coupled via belts to one of the primary timer pulley 425 and the secondary timer pulley 505.

The rotation of the secondary timer pulley 505 results in a rotation of the encoder driver pulley 520 coupled to the secondary timer pulley 505. The encoder driver pulley 520 in turn drives the encoder driven pulley 535 via an encoder belt 540. The encoder belt 540 can run through the encoder driver pulley 520 and the encoder driven pulley 535. Further, each of the first belt 235, second belt 240 and the encoder belt 540 can be tooth belts.

A precise control over the motion of the carriage 205 is desired for providing positional accuracy and repeatability. In order to achieve and maintain the precise control, the imaging device 100 provided in one embodiment utilizes two sets of position encoders. The position encoders are employed to provide feedback on the position of the carriage 205.

The first encoder, referred to as a motor encoder 435 (see FIG. 4), is mounted on the drive motor 405 of the primary drive assembly 215 to measure the motion of the carriage 205 relative to an initial position of the carriage 205. The motor encoder 435 mounted on the drive motor 405 measures the motion of the carriage 205 relative to the position of the carriage 205 at the time of power-on. As can be expected, the position of the carriage 205 at power-on need not be, the same as the initial position. The position of the carriage 205 is an arbitrary position reached during the previous operation and prior to power off.

The ceiling mounted gantry system 125 can further comprise an absolute encoder 530 (see FIG. 5) coupled to the secondary drive assembly 220 for monitoring the position of the carriage 205. The absolute encoder 530 can be directly mounted on the encoder belt 540. The absolute encoder 530 when mounted directly on the load i.e., the encoder belt 540 eliminates the risk of position loss due to gearbox backlash or clutch disengagement.

The motor encoder 435 coupled to the drive motor 405 of the primary drive assembly 215 and the absolute encoder 530 coupled to the encoder belt 540 of the secondary drive assembly 220 complete a loop from the driving element i.e. drive motor 405 to the driven element i.e. the encoder belt 540. Thus the absolute encoder 530 introduced in the ceiling mounted gantry system 125 ensures a closed loop control. Further, the feedback for the brake device 515 in the secondary drive assembly 220 and the feedback for the operation of the clutch 420 in the primary drive assembly 215 is based on ratio monitoring logic of the absolute encoder 530 and the motor encoder 435.

Dual carriage readings provided by the absolute encoder 530 and the motor encoder 435 are further utilized to detect any single failure in the absolute encoder 530 or the motor encoder 435 by comparing the respective values of the readings of the absolute encoder 530 and the motor encoder 435. Any discrepancy triggers a safety mechanism that either performs some automatic recovery routine or stops any further motion of the carriage 205 until a human intervention occurs.

The motor encoder 435 and the absolute encoder 530 provide sufficient motion resolution to support the accuracy requirements in the imaging device 100. The encoders 435 and 530 can be selected to support an indexing feature. The index is a point on the encoder that is encountered once per revolution. It is to be noted that each of the motor encoder 435 and the absolute encoder 530 typically perform more than one revolution within a complete range of motion by the carriage 205.

Some of the advantages of the ceiling mounted gantry system 125 provided in various embodiments of the invention include, elimination of a single point failure of the first belt 235. During the failure of the first belt 235, the secondary drive assembly 220 helps in preventing the motion of the carriage 205 through the brake device 515 and the torque limiter 510. Alternatively, during the failure of the second belt 240 the motion of the ceiling mounted gantry system 125 can be brought to halt with the help of the transmission apparatus 410 comprising the gearbox 415 and the clutch 420. Thus, the ceiling mounted gantry empowered with dual belts namely the first belt 235 and the second belt 240, eliminates the single point failure of the first belt 235 and hence increases the reliability of the imaging device 100.

Further, the first belt 235 and the second belt 240 tensioned to a predetermined value avoid any chances of motion slippage or backlash in the drive assembly 215 and 220 and thus provide a smooth and jerk free motion of the carriage 205.

The ceiling mounted gantry system 125 provided herein includes the dual drive assembly comprising the primary drive assembly 215 and the secondary drive assembly 220. The introduction of the secondary drive assembly 220 helps in addressing an uncontrolled motion in the ceiling mounted gantry system 125, which ensures safety of the patient, medical staff and the equipment.

The stiff positive drive provided by the dual drive assembly 215 and 220 enables the gantry system 125 to provide a good positional accuracy and repeatability with minimum vibration, resulting in enhancement of precision in the image quality.

The clutch 420 in the primary drive assembly 215 operating on the PWM technique facilitates a slip in the primary drive assembly 215 in case of a collision. Thus the primary drive assembly 215 does not exert a force greater than the force equivalent to the torque limiter set value. This is desired for multiple reasons including the patient safety, to avoid collision with the surrounding environment and to avoid the resulting equipment damage. Further, during power off conditions, the gantry system 125 is configured to move with a human force equivalent to the torque limiter set value. This facilitates patient safety as the gantry system 125 can be pushed to a safe zone in case of an emergency.

The dual encoders 435 and 530 provide with provision to track the exact location of the carriage 205 at any given time. Thus the position information of the carriage 205 is available to manage angulations and collision avoidance. The introduction of the absolute encoder 530 also provides with a closed loop control over the motion of the carriage 205. Further, the absolute encoder 530 when mounted directly on the load i.e., on the encoder belt 540 eliminates the risk of position loss due to gearbox backlash or clutch disengagement.

The imaging device 100 with a low maintenance gantry system 125 provided herein is easy to install at the customer site and enables an easy serviceability.

In various embodiments of the invention, a ceiling mounted gantry system for an imaging device and an imaging device using a ceiling mounted gantry system are described. However, the embodiments are not limited and may be implemented in connection with different applications such as displacement applications. The application of the invention can be extended to other areas, for example positioning devices, industrial inspection systems, security scanners, particle accelerators, etc. The invention provides a broad concept of providing a dual belt drive and a dual drive assembly, which can be adapted in a similar positioning device. The design can be carried further and implemented in various forms and specifications.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A ceiling mounted gantry system comprising:
a carriage;
at least two elongated support rails placed beneath the ceiling and extending between opposing sides of the carriage;
a support structure coupled to the carriage;
a primary drive assembly mounted on the carriage; and
a secondary drive assembly mounted on the carriage.

2. The ceiling mounted gantry system of claim 1, further comprising:
a first belt coupled to the primary drive assembly; and
a second belt coupled to the secondary drive assembly.

3. The ceiling mounted gantry system of claim 1, wherein the primary drive assembly comprises:
a transmission apparatus comprising a gearbox and a clutch;
at least one primary timer pulley coupled to the transmission apparatus; and
a drive motor coupled to the transmission apparatus, wherein the drive motor is configured to drive the primary timer pulley through the transmission apparatus.

4. The ceiling mounted gantry system of claim 3, wherein the clutch is configured to operate on a pulse width modulation (PWM) signal.

5. The ceiling mounted gantry system of claim 3, wherein the primary drive assembly further comprises a motor encoder coupled to the drive motor.

6. The ceiling mounted gantry system of claim 2, wherein the secondary drive assembly comprises:
at least one secondary timer pulley;
a torque limiter coupled to the secondary timer pulley;
a brake device coupled to the torque limiter; and
an absolute encoder coupled to the second belt.

7. The ceiling mounted gantry system of claim 6, wherein the torque limiter comprises a torque limiter shaft comprising a first end and a second end, the first end being coupled to the secondary timer pulley and the second end being coupled to the brake device.

8. A ceiling mounted gantry system for an imaging device, the ceiling mounted gantry system comprising:
a carriage;
a support structure coupled to the carriage;
at least two elongated support rails placed beneath the ceiling and extending between opposing sides of the carriage;
a primary drive means for driving the carriage; and
a secondary drive means for driving the carriage.

9. The ceiling mounted gantry system of claim 8, wherein the primary drive means is configured for driving the carriage when the power supply to the gantry system is on.

10. The ceiling mounted gantry system of claim 9, wherein the primary drive means is configured for driving the carriage in response to a pulse width modulation (PWM) signal.

11. The ceiling mounted gantry system of claim 9, further comprising a motor encoder means for encoding the position of the carriage.

12. The ceiling mounted gantry system of claim 8, wherein the secondary drive means is configured for driving the carriage when the power supply to the gantry system is off.

13. The ceiling mounted gantry system of claim 12, further comprising a torque limiter means configured for facilitating the movement of the carriage when the power supply to the gantry system is off and a force at least equal to a predetermined value is applied to the carriage, wherein the predetermined value is based on a torque limiter set value.

14. The ceiling mounted gantry system of claim 13, further comprising an absolute encoder means for encoding the absolute position of the carriage.

15. An imaging device comprising:
a ceiling mounted gantry system, the ceiling mounted gantry system comprising a carriage, at least two elongated support rails placed beneath the ceiling and extending between opposing sides of the carriage, a support structure coupled to the carriage, a primary drive assembly coupled to the carriage and a secondary drive assembly coupled to the carriage;
a radiation detector coupled to the support structure of the ceiling mounted gantry system; and
a radiation source coupled to the support structure of the ceiling mounted gantry system.

16. The imaging device of claim 15, wherein the ceiling mounted gantry system further comprises:
a first belt coupled to the primary drive assembly; and
a second belt coupled to the secondary drive assembly.

17. The imaging device of claim 15, wherein the primary drive assembly comprises:
a transmission apparatus comprising a gearbox and a clutch;
at least one primary timer pulley coupled to the transmission apparatus; and
a drive motor coupled to the transmission apparatus, wherein the drive motor is configured to drive the primary timer pulley through the transmission apparatus.

18. The imaging device of claim 17, wherein the clutch is configured to operate on a pulse width modulation (PWM) signal.

19. The imaging device of claim 17, wherein the primary drive assembly further comprises a motor encoder coupled to the drive motor.

20. The imaging device of claim 16, wherein the secondary drive assembly comprises:
at least one secondary timer pulley;
a torque limiter coupled to the secondary timer pulley;
a brake device coupled to the torque limiter; and
an absolute encoder coupled to the second belt.

21. The imaging device of claim 20, wherein the torque limiter comprises a torque limiter shaft comprising a first end and a second end, the first end being coupled to the secondary timer pulley and the second end being coupled to the brake device.
